(19) United States
(12) Patent Application Publication
(10) Pub. No.: US 2025/0196568 A1
(43) Pub. Date: Jun. 19, 2025

(54) CONNECTION MODULE FOR A FLUID

(71) Applicant: VALEO SYSTEMES THERMIQUES, La Verriere (FR)

(72) Inventors: Andrew EGGEBROTEN, Auburn Hills, MI (US); Stephane PERNET, La Verriere (FR); Baltazar CUEVAS, Auburn Hills, MI (US); Pascal GUIGOU, La Verriere (FR)

(73) Assignee: VALEO SYSTEMES THERMIQUES, La Verriere (FR)

(21) Appl. No.: 18/543,326

(22) Filed: Dec. 18, 2023

(51) Int. Cl. B60H 1/00

(52) U.S. Cl. CPC B60H 1/00485; B60H 1/00571

(57) ABSTRACT

A connection module for a fluid, including: a body with a first opening and a second opening connected to each other by a channel so that the fluid can flow between the first opening and the second opening through the channel; a first valve placed inside the channel to control the flow of the fluid; a side passage configured to receive the first valve so that it can be placed within the channel. The channel has a first arm and a second arm arranged at an angle to the first arm. The connection module further includes a fixing element configured to be introduced through the side passage towards the first valve and immobilize the first valve.

### TECHNICAL FIELD

The present invention relates to a manifold for a fluid, e.g. refrigerant, serving as or supporting a distribution device of a thermal management system.

### BACKGROUND OF THE INVENTION

The development of electric vehicles has brought new issues to the automotive field, in particular in view of the limited autonomy of the electric battery as well as the limited space that can be dedicated to the thermal management system. For these reasons, compact thermal management systems become increasingly desired. Another driving factor is limitation of costs of virtually every subcomponent of a vehicle.

A thermal management system, i.e. heat exchange loop, can comprise a heat ventilation and air conditioning system (HVAC) condenser, an evaporator-condenser, an HVAC evaporator, a chiller, an accumulator/IHX (Internal Heat Exchanger), and a compressor.

A discrete connection module can serve as attachment point for several elements of the heat exchange loop. The connection module can be used to convey a liquid, for example a cooling liquid, e.g. including water, a refrigerant, or both in a separated arrangement. The liquid/fluid can be conveyed by inner channels of the connection module. The inner channels can be bores within the body of the connection module, and contained between external planar surfaces of the connection module.

### SUMMARY OF THE INVENTION

An object of the invention is a connection module for a fluid, comprising: a body with a first opening and a second opening connected to each other by a channel so that the fluid can flow between the first opening and the second opening through the channel; a first valve placed inside the channel to control the flow of the fluid; a side passage configured to receive the first valve so that it can be placed within the channel; wherein the channel has a first arm and a second arm arranged at an angle to the first arm; wherein the connection module further comprises a fixing element configured to be introduced through the side passage towards the first valve and immobilize the first valve.

In one example, the channel includes a first section with a first diameter and a second section with a second diameter, the first diameter being smaller than the second diameter, the channel including a step in-between the first section and the second section arranged so that the first valve rests at an end of the first section adjacent to the step and an end of the second section.

In one example, the fixing element is configured to enable flow between the first arm and the second arm.

In one example, the first valve is a check valve.

In one example, the angle is between and degrees.

In one example, the angle is degrees.

In one example, the fixing element is a second valve.

In one example, the fixing element includes a collar.

In one example, the collar is held in place by a cap.

In one example, the cap is integral with the collar.

In one example, the collar is held in place by a second valve.

In one example, the collar includes a side wall with an axial opening for the fluid and a side opening for the fluid so that the fluid can travel through the collar between the axial opening and the side opening.

In one example, the side opening is merged with the axial opening.

In one example, the side opening has a rectangular shape.

In one example, the side opening is separated from the axial opening.

In one example, the collar includes additional side openings, wherein together the side openings are evenly distributed around an extension axis of the collar.

### BRIEF DESCRIPTION OF DRAWINGS

The present invention will be described in greater detail below with reference to the drawings. In the drawings:

FIG. 1 shows an example of a connection module in a perspective view;

FIG. 2 shows a portion of a cross-section of the connection module of FIG. 1;

FIG. 3 shows an example of a fixing element of the connection module of FIGS. 1 and 2;

FIG. 4 shows a portion of a cross-section of the connection module of FIG. 1 with another example of the fixing element;

FIG. 5 shows the fixing element of FIG. 4;

FIG. 6 shows another example of a connection module in a perspective view with schematically shown inside portion thereof; and

FIG. 7 shows the fixing element of FIG. 6.

### DETAILED DESCRIPTION OF THE INVENTION

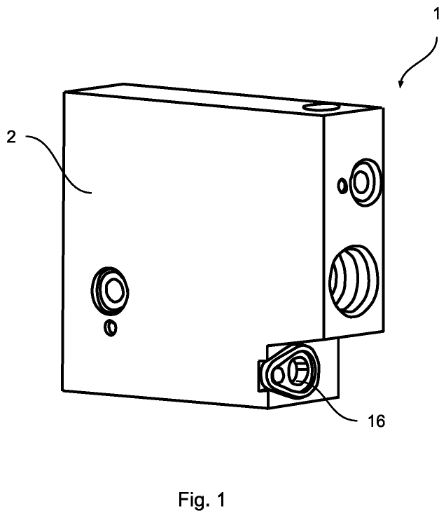

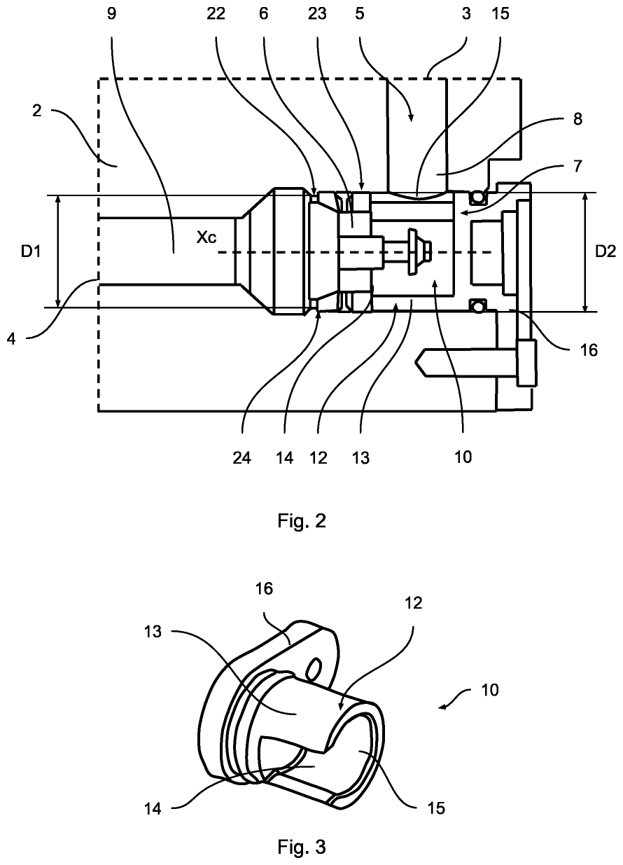

FIG. 1 shows an example of a connection module 1 in a perspective view, with FIG. 2 showing a portion of a cross-section of said connection module 1.

The connection module 1 is intended for handling a fluid. The fluid can be for example a refrigerant (e.g. R744, 1234f, R134a) or a coolant (e.g. a water-glycol mixture). The connection module 1 includes a body 2.

In general, the connection module 1 can be made of metal, plastic or a combination of both. The connection module 1 can be a machined metal block. The connection module 1 can be made of several parts connected together, e.g. brazed, welded, glued and/or screwed, with adequate sealing.

The connection module 1 can have a plurality of external planar surfaces.

Preferably, there are at least three, main external planar surfaces perpendicular to each other. The external planar surfaces can serve as surfaces to which elements can connect directly.

The external planar surfaces can serve as surfaces to which at least one of the following elements connects directly, or substantially directly: a valve, a pump, a compressor, a fluid handling component, another manifold, a connector, a sensor, an accumulator, a receiver drier, a liquid reservoir, a heat exchanger, a plate heat exchanger, a, air-liquid heat exchanger, a chiller, a condenser, a radiator, a liquid-cooled condenser, an internal heat exchanger, a heater, an electric heater, another manifold, a motor, a socket, a bracket.

The connection module 1 can have fluid openings, e.g. inlets and outlets connecting the inner channels.

Inlets, outlets and inner channels can be formed on different levels. The inner channels can transition between the levels. By levels, it can be meant a substantially constant distance measured in relation to a selected external planar surface.

The connection module 1 can have mounting openings, e.g. screw holes or positioning holes.

In addition to elements that communicate with each other fluidically through inner channels of the connection module 1, other elements that do not operate directly with the fluid/fluids can also be attached to the manifold.

The elements can be attached to the connection module 1, for example, by means of: a screw connection, a welding connection, a brazing connection, adhesive.

The body 2 includes a first opening 3 and a second opening 4. The first opening 3 and the second opening 4 are connected to each other by a channel 5. The channel 5 is arranged so that the fluid can flow between the first opening 3 and the second opening 4 through the channel 5.

The body 2 further includes a first valve 6. The first valve 6 is placed inside the channel 5 in order to control the flow of the fluid. The first valve 6 can be a check valve. The first valve 6 can also be a shut-off valve, pressure-regulating valve or expansion valve. The first valve 6 is placed in the channel 5 so that the fluid can pass through the first valve 6.

The body 2 further includes a side passage 7. The side passage 7 is configured to receive the first valve 6 so that it can be placed within the channel 5. In other words, the side passage 7 is adapted to receive the first valve 6 with an access to the channel 5, so that the first valve 6 can cooperate with the channel 5, and in particular with the fluid passing through the channel 5. For example, the first valve 6 can be occupying the whole section of the channel 5 to be able to fully control the behavior of the fluid.

The channel 5 has a first arm 8 and a second arm 9. The second arm 9 is arranged at an angle to the first arm 8. In other words, the second arm 9 is arranged in a non-parallel relationship with respect to the first arm 8.

The connection module 1 further includes a fixing element 10. The fixing element 10 is configured to be introduced through the side passage 7 towards the first valve 6 and subsequently immobilize the first valve 6. This means that the first valve 6 can be immobilized by an element that is easy to remove after assembly. Such configuration is advantageous for example, if servicing of the connection module 1 or of the first valve 6 is needed. For example, the first valve 6 can need maintenance or replacement.

In one example, the channel 5 includes a first section 22. The first section 22 has a first diameter D1. The channel 5 also includes a second section 23 with a second diameter D2. The second diameter D2 is adapted to allow the first valve 6 reception. For example, the second diameter D2 can correspond to dimensions of the first valve 6. For example, the first valve 6 can have a cylindrical shape defined by a diameter, with the second diameter D2 corresponding to diameter of the first valve 6. The first section 22 is adjacent to the second section 23. The first diameter D1 can be smaller than the second diameter D2. Further, the channel 5 can include a step 24 in-between the first section 22 and the second section 23. The step 24 can be produced by a difference between adjacent first diameter D1 and second diameter D2. In one example, there is no transition between the first diameter D1 and the diameter D2, in particular no gradual transition. Thus, step 24 can be provided. The step 24 can be arranged so that the first valve 6 rests at an end of the first section 22 adjacent to the step 24 and an end of the second section 23. In other words, the channel 5 is shaped so that at a defined point the first valve 6 is unable to be introduced further thereinto and its position can be fixed.

In one example, the fixing element 10 can configured to enable flow between the first arm 8 and the second arm 9. In other words, the fixing element 10 can be arranged to allow the fluid flow through it, for example in a desired direction.

As mentioned above, the second arm 9 is arranged at an angle to the first arm 8. In one example, the angle can be between 15 and 165 degrees. In a further, more specific example, the angle can be 90 degrees. In other words, the second arm 9 can be arranged perpendicularly with respect to the first arm 8.

In one example, the fixing element 10 can include a collar 12. The collar 12 can be a hallow member, through which the fluid can flow. The collar 12 can be a tubular element. The collar 12 can also be a frame element. The function of the collar 12 is to provide a physical blocking action between components, in this case the first valve 6 and the fixing element 10, while still enabling the fluid to travel.

In one example, the collar 12 can be held in place by a cap 16. In a further, more specific example, the cap 16 can be integral with the collar 12. Alternatively, the collar 12 and the cap 16 can be separate elements, which either cooperate by contact, through a shape connection or are connected to each other, e.g. by a screw connection, an adhesive or others.

FIG. 3 shows an example of a fixing element of the connection module of FIGS. 1 and 2. In this example, the collar 12 can include a side wall 13 with an axial opening 14 for the fluid and a side opening 15 for the fluid. The axial opening 14 and the side opening 15 can be arranged so that the fluid can travel through the collar 12 between the axial opening 14 and the side opening 15. Such configuration enables angular arrangement between the first arm 8 and the second arm 9 of the channel 5.

In one example, the side opening 15 can be merged with the axial opening 14. In other words, the axial opening 14 and the side opening 15 create a single opening.

In one example, the side opening 15 can be a rectangular shape.

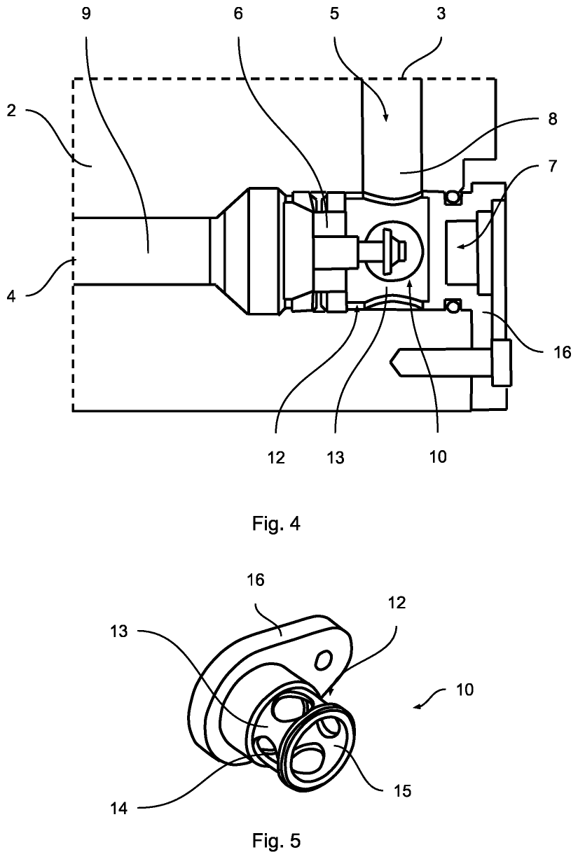

FIG. 4 shows a portion of a cross-section of the connection module 1 of FIG. 1 with another example of the fixing element 10, with FIG. 5 showing the respective fixing element 10 in isolation.

In one example, the side opening 15 can be separated from the axial opening 14.

In one example, the fixing element 10 can include additional side openings 15. Together, the side openings 15 can be evenly distributed around an extension axis Xc of the collar 12 along which the collar 12 extends. This further enhances flexibility in terms of angular arrangement of the first arm 8 and the second arm 9 for a single design of the collar 12.

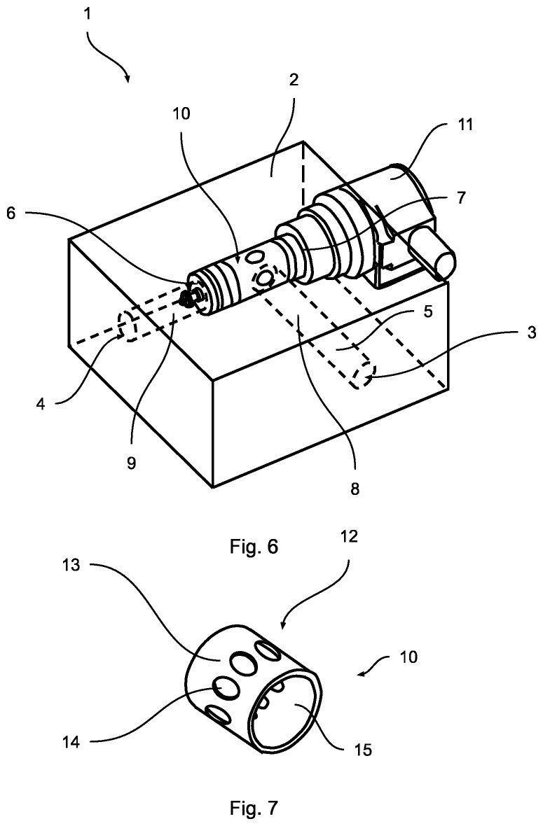

FIG. 6 shows another example of a connection module 1 in a perspective view with schematically shown inside portion thereof, with FIG. 7 showing the fixing element 10 of FIG. 6 in isolation.

In one example, the fixing element 10 can be a second valve 11. For example, the second valve can be introduced, for instance partly, into the side opening 15 and fixed with respect to the connection module 1 so that the second valve 11 immobilize the first valve 6.

In one example, the fixing element 10 can include a collar 12. In other words, the collar 12 can be integrated with the second valve 11—not shown. Alternatively, the collar 12 can be held in place by a second valve 11, as it is the case for the example of FIG. 6.

Other variations to the disclosed embodiments can be understood and effected by those skilled in the art in practicing the claimed invention, from a study of drawings, the disclosure, and the appended claims. The mere fact that certain measures are recited in mutually different dependent claims does not indicate that a combination of these measures cannot be used to the advantage.

1. A connection module for a fluid, comprising:
a body with a first opening and a second opening connected to each other by a channel so that the fluid can flow between the first opening and the second opening through the channel;
a first valve placed inside the channel to control the flow of the fluid;
a side passage configured to receive the first valve so that it can be placed within the channel;
wherein the channel has a first arm and a second arm arranged at an angle to the first arm;
wherein the connection module further comprises a fixing element configured to be introduced through the side passage towards the first valve and immobilize the first valve.

2. The connection module according to claim 1, wherein the channel includes a first section with a first diameter and a second section with a second diameter, the first diameter being smaller than the second diameter, the channel including a step in-between the first section and the second section arranged so that the first valve rests at an end of the first section adjacent to the step and an end of the second section.

3. The connection module according to claim 1, wherein the fixing element is configured to enable flow between the first arm and the second arm.

4. The connection module according to claim 1, wherein the first valve is a check valve.

5. The connection module according to claim 1, wherein the angle is between 15 and 165 degrees.

6. The connection module according to claim 1, wherein the angle is degrees.

7. The connection module according to claim 1, wherein the fixing element is a second valve.

8. The connection module according to claim 1, wherein the fixing element includes a collar.

9. The connection module according to claim 8, wherein the collar is held in place by a cap.

10. The connection module according to claim 9, wherein the cap is integral with the collar.

11. The connection module according to claim 8, wherein the collar is held in place by a second valve.

12. The connection module according to claim 8, wherein the collar includes a side wall with an axial opening for the fluid and a side opening for the fluid so that the fluid can travel through the collar between the axial opening and the side opening.

13. The connection module according to claim 12, wherein the side opening is merged with the axial opening 14.

14. The connection module according to claim 12, wherein the side opening has a rectangular shape.

15. The connection module according to claim 12, wherein the side opening is separated from the axial opening.

16. The connection module according to claim 12, wherein the collar includes additional side openings, wherein together the side openings are evenly distributed around an extension axis of the collar.
